(19) United States
(12) Patent Application Publication
(10) Pub. No.: US 2026/0095204 A1
(43) Pub. Date: Apr. 2, 2026

(54) METHODS, DEVICES AND SYSTEMS FOR RADIO FREQUENCY CIRCUIT HAVING RECEIVE-TRANSMIT CO-MATCHING NETWORK

(71) Applicant: Cypress Semiconductor Corporation, San Jose, CA (US)

(72) Inventors: Shu-Hsien Liao, San Jose, CA (US); Burcin Baytekin, Menlo Park, CA (US)

(73) Assignee: Cypress Semiconductor Corporation, San Jose, CA (US)

(21) Appl. No.: 18/900,345

(22) Filed: Sep. 27, 2024

(51) Int. Cl. H04B 1/58; H04B 1/04; H04B 1/18

(52) U.S. Cl. CPC H04B 1/581; H04B 1/0475; H04B 1/18

(57) ABSTRACT

A method can include wireless circuits that, by operation of transmit switch circuits, include a transmit component in an output signal path between a transmit amplifier and an antenna port, the output signal path including a shared matching network. By operation of a transmit amplifier, an output signal can be generated for transmission over an output signal path to an antenna port. In a receive mode, by operation of the transmit switch circuits, an input impedance of the transmit component can be excluded from an input signal path between the antenna path and a receive amplifier. An input signal path can include the shared matching network. By operation of the receive amplifier, amplifying the received input signal. Corresponding devices and systems are also disclosed.

### TECHNICAL FIELD

The present disclosure relates generally to wireless systems, and more particularly to systems in which transmitter and receiver signal paths include a same impedance matching network.

### BACKGROUND

Wireless devices typically include transceiver circuits for transmitting and receiving wireless signals. To maximize power transfer from a transmitter source (e.g., power amplifier), transceiver circuits can include an impedance matching network. FIG. 18-0 shows a conventional transceiver circuit 1801 that can switch 1803 between a transmit path 1805 and a receive path 1807. A transmit path 1805 can include a transmit component 1809 (which can be inherent in the transmit circuits) as well as an impedance matching network 1811 for optimizing transmit power. A separate receive path 1807 can include a receive impedance 1813.

To reduce device size and cost, transceiver circuits can include a shared matching network. FIG. 18-1 shows a conventional transceiver circuit 1815 having a shared impedance matching network 1817. A shared matching network 1817 can be included in both transmit 1805 and receive paths 1807. Use of a shared matching network can reduce component cost and device size. An input impedance for an input signal can include that of the shared matching network 1817, the transmit component 1809, and the receive impedance 1819. However, the impedance presented by such diverse components can limit performance, including signal bandwidth.

It would be desirable to arrive at some way of reducing transceiver circuit component size and/or cost without suffering the resulting performance drawbacks of conventional approaches.

### SUMMARY

A method can include, by operation of wireless circuits, in a transmit mode, transmit switch circuits can include a transmit component in an output signal path between a transmit amplifier and an antenna port. The output signal path can include a shared matching network. By operation of the transmit amplifier, an output signal can be generated for transmission over the output signal path to the antenna port. In a receive mode, by operation of the transmit switch circuits, an input impedance of the transmit component can be excluded from an input signal path between the antenna path and a receive amplifier. The input signal path can include the shared matching network. The receive amplifier can amplify the received input signal.

### BRIEF DESCRIPTION OF DRAWINGS

FIGS. 1-0, 1-1, and 1-2 are block diagrams showing a system and operations according to an embodiment.

FIG. 2 is a block diagram of a system according to another embodiment.

FIG. 3 is a block diagram of a system according to a further embodiment.

FIG. 4 is a block diagram of a system according to another embodiment.

FIG. 5 is a block diagram of a system according to another embodiment.

FIG. 6 is a block schematic diagram of a system according to an embodiment.

FIG. 7 is a block schematic diagram of a system according to another embodiment.

FIG. 8 is a block schematic diagram of a system according to a further embodiment.

FIG. 9 is a block diagram of a system according to another embodiment.

FIGS. 10-0, 10-1, 10-2, 10-3, 10-4 and 10-5 are diagrams of shared matching impedance networks that can be included in embodiments.

FIG. 11 is a block diagram of a system according to another embodiment.

FIG. 12 is a block diagram of a mobile device according to an embodiment.

FIGS. 13-0, 13-1 and 13-2 are top plan views of systems according to embodiments.

FIGS. 14-0, 14-1, 14-2 and 14-3 are diagrams of a packaged devices that can be included in embodiments.

FIGS. 15-0, 15-1, 15-2 and 15-3 are diagrams of systems according to other embodiments.

FIG. 16 is a flow diagram of a method according to an embodiment.

FIG. 17 is a flow diagram of a method according to a further embodiment.

FIGS. 18-0 and 18-1 are block diagram of conventional transceiver circuits.

### DETAILED DESCRIPTION

According to embodiments, transceiver circuits of a wireless device can include a matching network through which signals are both transmitted and received. When signals are received, an impedance presented by transmission circuits can be excluded from an input impedance with respect to the input signal. In some embodiments, when signals are transmitted, an impedance presented by receiver circuits can be removed from a transmit load for the output signal.

In some embodiments, transceiver circuits can include a radio frequency (RF) transformer having a primary winding and secondary winding. In a receive mode, switching circuits can prevent current from flowing through the primary winding and/or secondary winding.

It is understood that excluding an impedance presented by a transmission circuits with respect to an input signal path can include increasing the input impedance presented by transmission components such that they have little if any adverse effect on a desired input impedance (e.g., a transmission component can present an open circuit).

It is understood that removing an impedance or receiver circuits from a transmit load, and can include creating a relatively low impedance across the receive components (e.g., a short across a receive component).

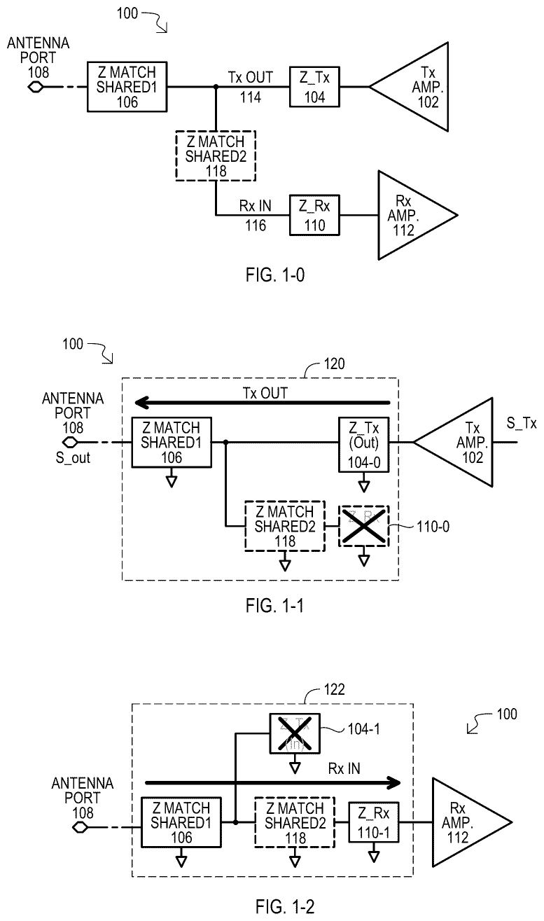

FIG. 1-0 is a diagram of a system 100 according to an embodiment. A system 100 can include a transmit amplifier 102, one or more transmit components 104, a shared impedance matching network (shared network) 106, one or more receive components 110, a receive amplifier 112, and optionally, additional matching components 118. A transmit output node 114 can be formed at an output of transmit components 104. A receive input node 116 can be formed at an input of receive components 110. A transmit amplifier 102 can amplify an output signal for transmission at antenna port 108. In some embodiments, a transmit amplifier 102 can include one or more power amplifiers (PAs). Transmit components 104 can include components for generating a desired output signal response (e.g., a transformer). Absent some change in configuration, transmit components can present an input impedance with respect to an input signal received antenna port 108 that can adversely affect a desired input impedance (e.g., limit a bandwidth range).

A shared network 106 can provide a matching impedance for optimizing or otherwise improving transmission power for an output signal. A shared network 106 can take any suitable form, including one or more passive circuit components (e.g., inductor, capacitor), and in some embodiments, one or more switching devices (e.g., transistor). A shared network 106 can be advantageously included in both an output signal path for output signals and an input signal path for input signals, thus a switching device for switching between transmit (Tx) and receive (Rx) signal paths may not be included.

A receive amplifier 112 can amplify an input signal received at antenna port 108. In some embodiments, a receive amplifier 112 can include one or more low noise amplifiers (LNAs). Receive components 118 can include components for conditioning an input signal, including but not limited to, filtering and/or arriving at a desired input impedance.

Additional matching components 118 can include one or more additional passive circuit components and optionally, one or more active circuit components to achieve a desired impedance for transmission and reception operations.

FIG. 1-1 shows a system 100 configured for a transmit mode 120. In a transmit mode 120, transmit amplifier 102 can amplify a output signal S_Tx. Transmit components 104-0 can have a transmit configuration that enables the transmission of the amplified signal output from transmit amplifier 102. A shared network 106 can be configured to enable the amplified signal to be driven at antenna port 108. In some embodiments, this can include a shared network 106 having, or being configured to have, an impedance that matches a signal source impedance presented by transmit components 104-0 and transmit amplifier 102. A resulting transmitted output signal S_Out can be driven at antenna node 108.

In some embodiments, additional matching components 118 can be included to provide a desired output matching impedance.

In some embodiments, in a transmit mode 120 receive components 110-0 can be configured to be essentially removed from a resulting output impedance.

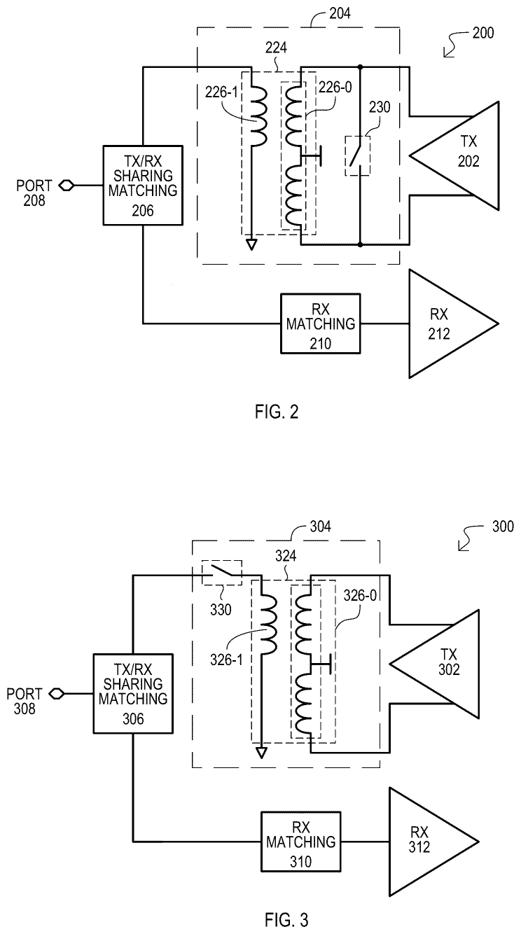

FIG. 1-2 shows a system 100 configured for a receive mode 122. In a receive mode 122, transmit components 104-1 can be configured to be essentially excluded from a resulting input impedance. An input signal (S_in) can be received at antenna port 108, pass through shared network 106, receive components 110-1, and received at an input of receive amplifier 112. Thus, while input signal S_in can be received through shared network 106, an impedance presented by transmit component 104-1 can be essentially excluded from an overall input impedance for the input signal S_in.

In this way, in a transmit operation, a system can transmit an output signal through a transmit component and shared matching impedance network. In a receive mode, an impedance presented by the transmit component can be essentially removed from an input impedance for an input signal received through the shared matching impedance network.

FIG. 2 is a diagram of a system 200 according to another embodiment. In some embodiments, a system 200 can be one implementation of that shown in FIG. 1-0. A system 200 can include items like those of FIG. 1-0, and such like items are referred to by the same reference character but with the leading digit being a “2” instead of “1”.

Referring still to FIG. 2, a transmit component 204 can include a transformer 224 and transmit switch circuit 230. A transformer 224 can include a primary winding 226-0 and secondary winding 226-1, and in some embodiments can be a RF transformer. In the embodiment shown, a primary winding 226-0 can have a center-tapped configuration, and be connected to outputs of transmit amplifier 202. Secondary winding 226-1 can be connected to shared network 206. In the embodiment shown, transmit switch circuit 230 can be disposed between terminals of primary winding 226-0.

In a transmit configuration, transmit switch circuit 230 can provide a high impedance path between terminals of primary winding 226-0. An output signal can be amplified by transmit amplifier 202 and driven across primary winding 226-0. The amplified output signal on primary winding 226-0 can induce a corresponding current through secondary winding 226-1, which can be output through shared network 206. Shared network 206 can have an impedance advantageous for transmit operations.

In a receive configuration, transmit switch circuit 230 can provide a low impedance path between terminals of primary winding 226-0, preventing current flow through primary winding 226-0, essentially removing any reactivity introduced by a transformer response to an input signal. While FIG. 2 shows a transmit switch circuit 230 with switching between terminals of primary winding, embodiments can include other switching devices (e.g., isolating primary winding from a power source).

In this way, a system can transmit output signals through a RF transformer and shared matching impedance network. The system can essentially exclude RF transformer effect on input impedance for an input signal by preventing current flow through a primary winding of the RF transformer.

FIG. 3 is a diagram of a system 300 according to a further embodiment. In some embodiments, a system 300 can be one implementation of that shown in FIG. 1-0. A system 300 can include items like those of FIG. 2, and such like items are referred to by the same reference character but with the leading digit being a “3” instead of “2”.

Referring to FIG. 3, a transmit component 304 can include a transformer 324 and transmit switch circuit 330. A transformer 324 can include a primary winding 326-0 and secondary winding 326-1. Unlike FIG. 2, transmit switch circuit 330 can be disposed between secondary winding 326-1 and shared network 306.

In a transmit configuration, transmit switch circuit 330 can provide a low impedance path between second winding 326-1 and shared network 306. An output signal can thus be induced on secondary winding 326-1 for output through shared network 306 to antenna port 308.

In a receive configuration, transmit switch circuit 330 can provide a high impedance, essentially isolating transformer 324 from an input signal path. This can essentially exclude the input impedance presented by the transformer 324 from an input signal path.

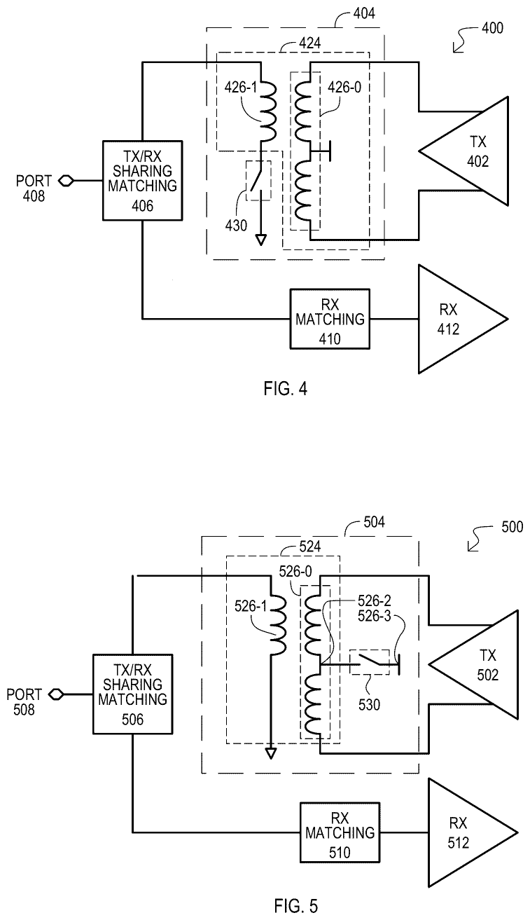

FIG. 4 is a diagram of a system 400 according to a further embodiment. In some embodiments, a system 400 can be one implementation of that shown in FIG. 1-0. A system 400 can include items like those of FIG. 3, and such like items are referred to by the same reference character but with the leading digit being a “4” instead of “3”.

FIG. 4 differs from FIG. 3 in that a transmit switch circuit 404 can be located between a secondary winding 426-1 and a current path to a reference potential (e.g., ground, VSS). In a transmit configuration, a switch circuit 404 can provide a low impedance path and operate in the same essential manner as FIG. 3. In a receive configuration, a switch circuit 404 can provide a high impedance path and operate in the same essential manner as FIG. 3.

In this way, systems can transmit output signals through a RF transformer and shared matching impedance network. The system can essentially exclude RF transformer effect on input impedance by isolating a secondary winding of the RF transformer from an input signal path that includes the same shared matching impedance network.

FIG. 5 is a diagram is a diagram of a system 500 according to another embodiment. In some embodiments, a system 500 can be one implementation of that shown in FIG. 1-0. A system 500 can include items like those of FIG. 2, and such like items are referred to by the same reference character but with the leading digit being a “5” instead of “2”.

Referring still to FIG. 5, a transmit component 504 can include a transformer 524 and transmit switch circuit 530. Transmit switch circuits 530 can be positioned between a primary winding tap node 526-2 and a current source node 526-3 (e.g., power supply node or other reference voltage node). In a transmit configuration, transmit switch circuit 530 can provide a low impedance path between tap node 526-2 and current source node 526-3, enabling current to flow through primary winding 526-0 when driven by transmit amplifier 502. In a receive configuration, transmit switch circuit 530 can provide a high impedance path between tap node 526-2 and current source node 526-3, preventing current from flowing through primary winding 526-0. This can reduce or essentially exclude any reactivity introduced by a transformer response to an input signal.

In this way, a system can transmit output signals through a RF transformer and shared matching impedance network. The system can essentially remove RF transformer effect on input impedance for an input signal by isolating a primary winding from a current source and/or sink.

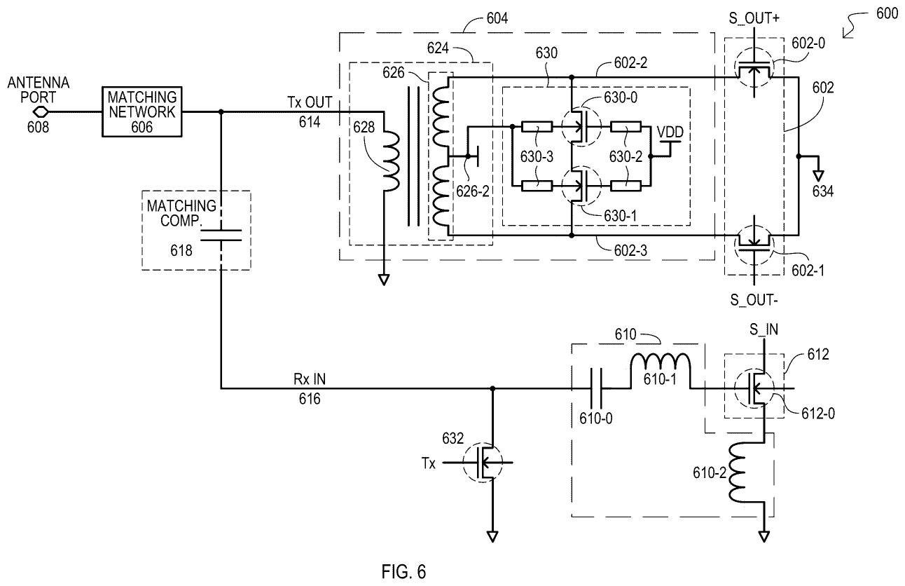

FIG. 6 is a diagram of a system 600 according to another embodiment. In some embodiments, a system 600 can be one implementation of that shown in FIG. 1-0. A system 600 can include a transmit amplifier 602, transmit components 604, shared network 606, an antenna port 608, receive components 610, receive amplifier 612, receive switching circuits 632, and optionally, additional matching components 618. A transmit amplifier 602 can include various components including but not limited to, a first drive transistor 602-0 and second drive transistor 602-1. A first driving transistor 602-0 can have a source-drain path connected between a low power supply node (e.g., ground) 634 and a first output node 602-2, and receive an input signal (S_OUT+) at a gate. A second driving transistor 602-1 can have a source-drain path connected between node 634 and a second output node 602-3, and receive an input signal (S_OUT−) at a gate.

Transmit components 604 can include RF transformer 624 and transmit switch circuits 630. RF transformer 624 can include a primary winding 626 with a center tap node 626-2 and secondary winding 628. Transmit switch circuits 630 can include first and second switch transistors 630-0/1 having source drain paths disposed in series between output nodes 602-2/3. Gates of first and second switch transistors can be connected to a high power supply (VDD) by gate load devices 630-2. Bodies of first and second switch transistors can be connected to center tap node 626-2 by gate body load devices 630-3. A center tap node 626-2 can be at a high power supply (VDD).

Matching network 606 can take the form of any of those described herein or equivalents. In the embodiment shown, matching network 606 can be located between antenna port 608 and output node 614 and input node 616. Optionally, additional matching components 618 can be located between output node 614 and input node 616. Additional matching components can include one or more additional components for establishing a desired transmit and receive impedance response.

Receive switching circuit 632 can be located between input node 616 and a reference supply node (e.g., ground). In the embodiment shown, receive switching circuit 632 can include a transistor having a source-drain path connected between input node 616 and ground, and a gate that receives a transmit mode signal (Tx).

Receive components 610 can include passive circuit elements for a desired input signal response. In the embodiment shown, receive components 610 can include a capacitance 610-0 and first inductance 610-1 in series between input node 616 and an input of receive amplifier 612. A second inductance 610-2 can be included in a current path for receive amplifier 612.

A receive amplifier 612 can include, but is not limited to, at least one receive transistor 612-0 having a source-drain path between an input signal node S_IN and a reference node, and a gate that receives an input signal. In the embodiment shown, input transistor 612-0 can have a gate connected to a terminal of first inductance 610-1 and a source connected to a terminal of second inductance 610-2. It is understood that a transistor 612-0 can have various biasing circuits to establish a desired response.

In the embodiment shown, transistors 602-0/1, 630-0/1, 632 and 612-0 can be n-channel insulated gate field effect transistors, however, this should not be construed as limiting. Alternate embodiments can include different types of active devices and/or different conductivity devices with suitable biasing and arrangement in the circuit.

In a transmit mode, transmit amplifier 602 can be active, with first or second drive transistors 602-0/1 receiving differential output signal (S_OUT+/−). As a result, current can flow through corresponding portions of primary winding 626, which can induce a current in secondary winding 628. This can generate a signal on a transmit output node 614. A signal on output node 614 can be transmitted through matching network 606 to antenna port 608, where matching network 606 minimizes or otherwise reduced power loss of an output signal.

Also in a transmit mode, receive switching circuits 632 can connect input node 616 to ground (e.g., signal Tx is high). If additional matching components 618 are present, such components can serve as part of the load for an output signal. With input node 616 connected to ground, an impedance presented by receive components 610 can be essentially removed from an output load.

In a receive mode, transmit amplifier 602 can be inactive, with first and second drive transistors 602-0/1 being turned off (i.e., in a high impedance state). Due to biasing from gate and body devices 630-2/3, first and second transistors 630-0/1 can be turned on, creating a low impedance path between terminals of primary winding 626, preventing current flow through the primary winding 626. In such an arrangement, an input impedance presented by transmit components 604 for an input signal can be essentially excluded from an input signal impedance.

Also in a receive mode, receive switching circuits 632 can isolate input node 616 from ground. An input signal at antenna port 608 can pass through matching network 606, and optionally additional matching components 618, and be received by receive components 610 and receive amplifier 612.

In this way, when a transmit amplifier of a transceiver system is inactive, switching circuits can automatically prevent current flow through a transmit RF transformer to prevent a reactivity of the RF transformer from adversely affecting a desired input impedance of the system.

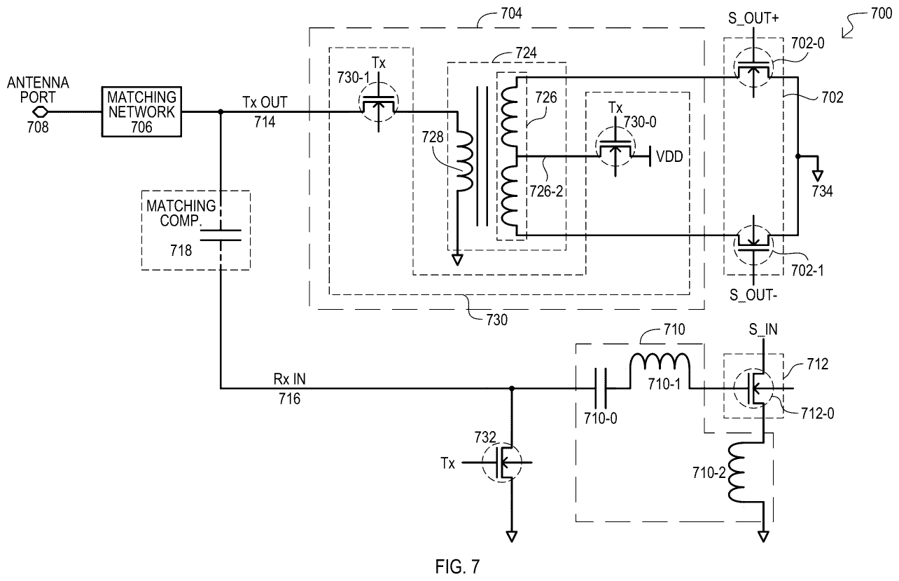

FIG. 7 is a diagram of a system 700 according to another embodiment. A system 700 can include items like those of FIG. 6, and such like items are referred to by the same reference characters, but with the leading digit being “7” instead of “6”.

FIG. 7 can differ from FIG. 6 in that transmit switching circuits 730 can include a first switch transistor 730-0 having a source-drain path between a primary winding tap node 726-2 and a high power supply (VDD), and a gate that receives a Tx signal. Further, a second switch transistor 730-1 can have a source-drain path between a secondary winding 728 and output node 714, and a gate that receives a Tx signal.

In a transmit mode, transmit amplifier 702 can be active, with first or second drive transistors 602-0/1 being driven by output signal (S_OUT+/−). First switch transistor 730-0 is turned on, enabling transmit amplifier 702 to drive current through portions of primary winding 726. Second switch transistor 730-1 is also turned on, allowing induced current in secondary winding 728 to be driven on output node 714. Receive switching circuit 732 can connect input node 716 to ground. Thus, a signal on output node 714 can be output through matching network 706 (and with additional matching components 716 as a load, if included).

In a receive mode, transmit amplifier 702 can be inactive, with first and second drive transistors 702-0/1 being turned off (i.e., in a high impedance state). First switch transistor 730-0 can be turned off, isolating primary winding 726 from a high power supply VDD. Second switch transistor 730-1 can also be turned off, isolating transmit components 704 from an input signal path. This can essentially exclude the impedance presented by transformer 724 to an input signal (e.g., transformer has a very high impedance). Receive switching circuit 732 can also be turned off, enabling an input signal path from antenna node 708, through matching network 706 (and through additional matching components 718, if present) to receive components 710 and receive amplifier 712.

In this way, in a transmit mode, a transmit transformer can have a secondary winding isolated from an input signal path, and a current path for primary windings can be disabled.

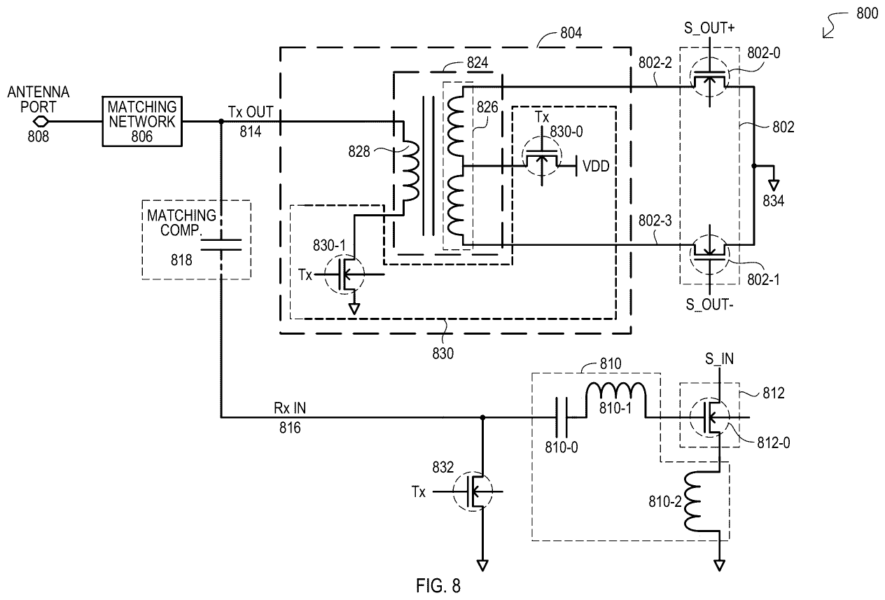

FIG. 8 is a diagram of a system 800 according to another embodiment. A system 800 can include items like those of FIG. 7, and such like items are referred to by the same reference characters, but with the leading digit being “8” instead of “7”. FIG. 8 can differ from FIG. 7 in that transmit switching circuits 830 can include a second transistor 830-1 having a source-drain path between a secondary winding 828 and a low power supply (e.g., ground). A system 800 can operate in the same general fashion as described for FIG. 7.

In this way, in a transmit mode, a transmit transformer can have a secondary winding isolated from a current sink path, and a current path for primary windings can be disabled.

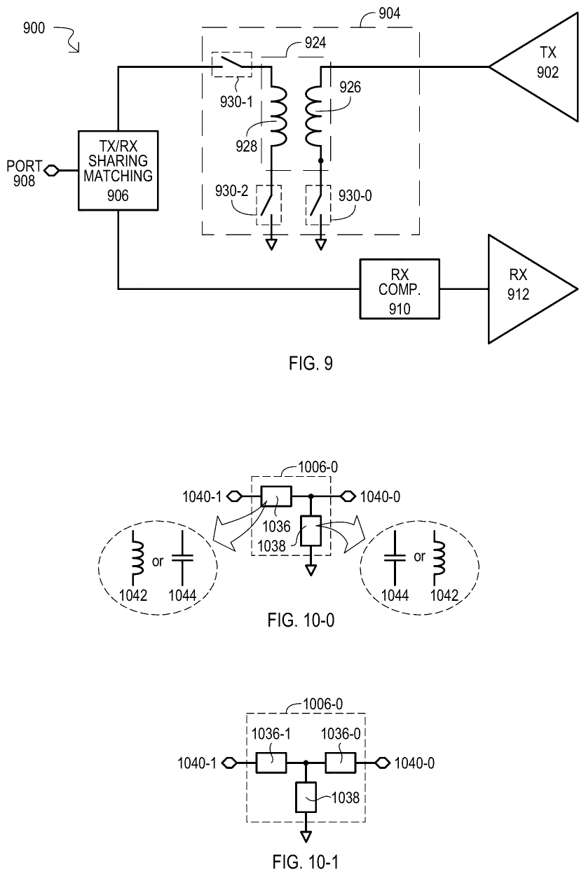

FIG. 9 is a diagram of a system 900 according to a further embodiment. In some embodiments, a system 900 can be one implementation of that shown in FIG. 1-0. A system 900 can include items like those of FIG. 2, and such like items are referred to by the same reference character but with the leading digit being a “9” instead of “2”.

Referring still to FIG. 9, a transformer primary winding 926 may not be tapped as in the case of FIG. 2. Further, transmit components 904 can include any of a first switch circuit 930-0, second switch circuit 930-1 or third switch circuit 930-2. In some embodiments, in a transmit mode, a first switch circuit 930-0 can enable a current path between primary winding 926 and a current supply node (e.g., ground). Transmit amplifier 902 can thus drive a current through primary winding 926 which can be induced on secondary winding 928. In a receive mode, first switch circuit 930-0 can have a high impedance, preventing current from flowing through primary winding 926.

In addition or alternatively, in a transmit mode, a second switch circuit 930-1 can enable a current path between secondary winding 928 and shared network 906 to enable an output signal through shared network 906 to antenna port 908. In a receive mode, second switch circuit 930-1 can have a high impedance, essentially removing transmit components 904 from an input impedance.

In addition or alternatively, in a transmit mode, a third switch circuit 930-2 can enable a current path between secondary winding 928 and current supply node, to enable a current through primary winding 926 to be induced on secondary winding 928. In a receive mode, third switch circuit 930-2 can have a high impedance, preventing current from flowing through secondary winding 928.

In this way, a system can have a transmit transformer in which current can be prevented from flowing in a primary and/or secondary winding in a receive mode, reducing or essentially removing an adverse input impedance presented by the transformer.

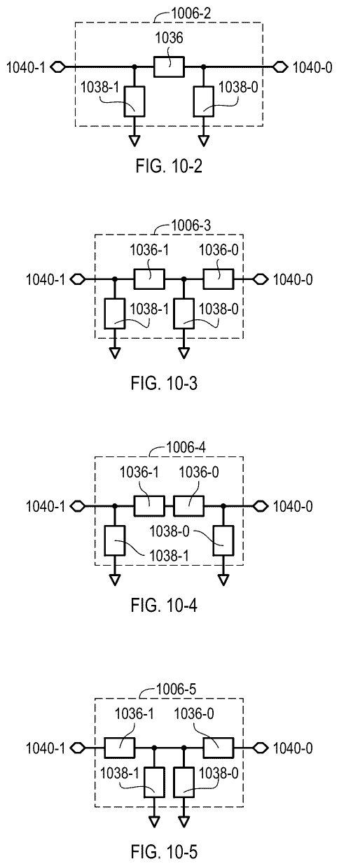

FIGS. 10-0 to 10-5 are diagrams of shared networks that can be included in embodiments. Referring to FIG. 10-0, a shared network 1006-0 can include a first terminal 1040-0, a second terminal 1040-1, a serial element 1036 and a parallel element 1038. A shared network 1006-0 can have a first terminal 1040-0 connected, directly or indirectly, to a transmit amplifier and receive amplifier, and a second terminal 1040-1 connected, directly or indirectly, to an antenna node, or vice versa.

A serial element 1036 can include an inductance 1042 or capacitance 1044. A parallel element 1038 can include a capacitance 1046 or inductance 1048. Any of the inductances 1042/1048 or capacitance 1044/1046 can be static and/or dynamic. In the latter case, switching devices/circuits can switch elements in parallel and/or series to alter a capacitance/inductance.

FIG. 10-1 shows a matching network 1006-1 having two serial elements 1036-0/1 and one parallel element 1038. Each such elements can be an inductance or capacitance as described for FIG. 10-0. FIG. 10-2 shows a matching network 1006-2 having one serial element 1036 arranged between two parallel elements 1038-0/1. Each such element can be an inductance or capacitance as described for FIG. 10-0.

FIG. 10-3 shows a matching network 1006-3 having two serial elements 1036-0/1, with a second serial element 1036-1 between two parallel elements 1038-0/1. Each such element can be an inductance or capacitance as described for FIG. 10-0. FIG. 10-4 shows a matching network 1006-4 having two serial elements 1036-0/1 between two parallel elements 1038-0/1. Each such element can be an inductance or capacitance as described for FIG. 10-0. FIG. 10-5 shows a matching network 1006-5 having two parallel elements 1038-0/1 between two serial elements 1036-0/1. Each such element can be an inductance or capacitance as described for FIG. 10-0.

In this way, embodiments can include matching impedance networks having elements in various configurations and numbers. It is understood that embodiments are not limited to the matching networks shown in FIGS. 10-0 to 10-5.

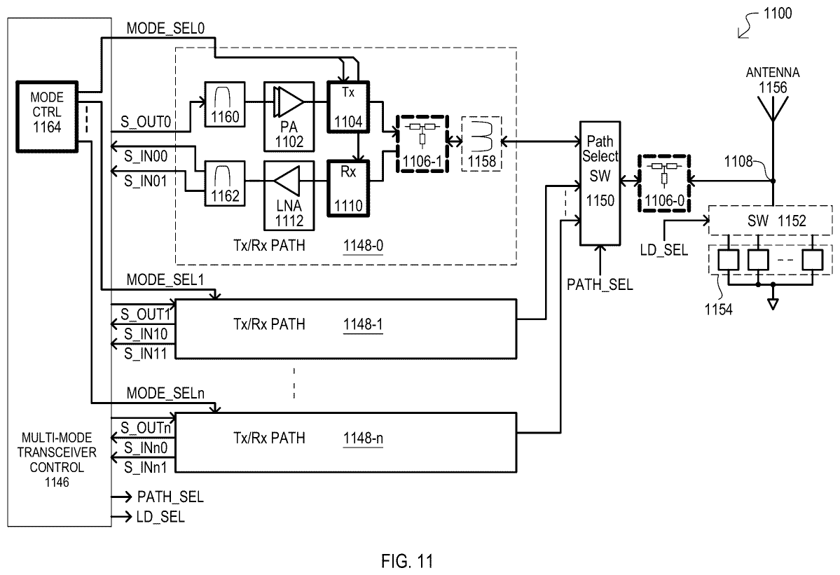

FIG. 11 is a diagram of a system 1100 according to an embodiment. In some embodiments, a system 1100 can be a front end of a wireless device. A system 1100 can include a multi-mode transceiver control circuit 1146, a number of Tx/Rx paths 1148-0 to 1148-n, a path select circuit 1150, antenna node 1108, and an antenna system 1156. Optionally, a system 1100 can include load switch 1152 and load elements 1154.

A system 1100 can include a shared network 1106-0 between antenna node 1108 and path select switch 1150. In addition or alternatively, each Tx/Rx path 1148-0 to -n can include its own shared network (one shown as 1106-1). A shared network 1106-0 or 1106-1 can be in the signal path of both a transmitted signal and received signal. A shared network 1106-0 or 1106-1 can take the form of any of those described herein or equivalents.

A multi-mode transceiver control circuit 1146 can provide output signals S_OUT0 to S_OUTn, provide path select signals PATH_SEL, provide load select signals LD_SEL, and receive input signals S_IN00/01 to S_INn0/n1. A multi-mode transceiver control circuit 1146 can include a mode control section 1164, which can generate mode control signals MODE_SEL0 to MODE_SELn.

Each of Tx/Rx paths (1148-0 to -n) can be placed into a transmit mode or receive mode according to corresponding mode select signals (MODE_SEL0 to n). In a transmit mode, a Tx/Rx path (1148-0 to -n) can amplify a corresponding output signal (S_OUT0 to -n) for transmission through a shared network (e.g., 1106-0 and/or 1106-1) to antenna system 1156. In a receive mode, a Tx/Rx path (1148-0 to -n) can receive signals from antenna system 1156 through a shared network (e.g., 1106-0 and/or 1106-1), and amplify such signals to provide corresponding input signals (S_IN00/01 to -n0/n1).

Referring to Tx/Rx path 1148-0, each Tx/Rx path 1148-0 can include an output filter circuit 1160, a PA circuit 1102, transmit components 1104, receive components 1110, a LNA circuit 1112, and an input filter circuit 1162. Optionally, a Tx/Rx path (e.g., 1148-0) can include a path shared network 1106-1 and input/output (IO) filter circuit 1158. An output filter circuit 1160 can filter an output signal (e.g., S_OUT0) received from multi-mode transceiver control circuit 1146. In some embodiments, an output filter circuit 1160 can be a band pass filter. A PA circuit 1102 can include one or more power amplifiers, and can take the form of any of those described herein or equivalents. Transmit components 1104 can condition signals output from PA circuits 1102 for transmission from Tx/Rx path 1148-0, and can take the form of any of those described herein or equivalents, including an RF transformer. Accordingly, in response to a mode select signal (MODE_SEL0 to -n), transmit components 1104 can transmit an output signal in one configuration (e.g., transmit), and can be essentially excluded from affecting an input impedance in another configuration (e.g., receive). It is noted that in some embodiments, transmit components 1104 and PA circuits 1102 may advantageously be part of a same integrated circuit (IC) device.

Referring still to Tx/Rx path 1148-0, receive components 1110 can condition input signals received over antenna system 1156, and can take the form of any of those described herein or equivalents. Accordingly, in response to a mode select signal (MODE_SEL0 to -n), receive components 1110 can receive an input signal in one configuration (e.g., receive), and can be essentially removed from affecting an output load/impedance in another configuration (e.g., transmit).

LNA circuits 1112 can include one or more LNAs for amplifying input signals to generate input signals (e.g., S_IN00/01) for input to multi-mode transceiver control circuit 1146. Input filter circuits 1162 can filter an input signal provided by LNA circuits 1112. In some embodiments, input filter circuits 1162 can include one or more band pass filters.

A Tx/Rx path 1148-0 may include a path shared network 1106-1. A path shared network 1106-1 can provide a matching impedance through which signals for Tx/Rx path 1148-0 are both received and transmitted. An IO filter 1158 can be included to filter output signals and/or input signals.

A path select circuit 1150 can connect antenna node 1108 to an Rx/Tx path (1148-0 to -n) in response to path select signals (PATH_SEL). It is understood that such paths are input/output paths, enabling transmission of an output signal over antenna system 1156 as well as the receipt of one or more input signals received by antenna system 1156.

A system 1100 can include a shared network 1106-0 between antenna port 1108 and path select circuit 1150. A shared network 1106-1 can provide a matching impedance through which signals for Tx/Rx paths (1148-0 to -n) can be received and transmitted. Optionally, a system 1100 can include load switching circuit 1152, for selectively switching load impedance elements 1154 between antenna node 1108 and a ground node.

In the embodiment shown, Tx/Rx paths 1148-0 can provide two input signals.

However, alternate embodiments can include fewer or greater numbers of input signals. It is understood that embodiments can include a shared network 1106-0 shared by input and output signals for all Tx/Rx paths (1148-0 to -n), or a path shared network 1106-1 shared by input and output signals for the corresponding Tx/Rx path, or both.

In this way, a system can include multiple transmit/receive paths that can share a matching impedance network for output and input signals. The transmit/receive paths can include transmit components for transmitting signals in a transmit mode. An input impedance presented by such transmit components can be essentially excluded from an input impedance in a receive mode.

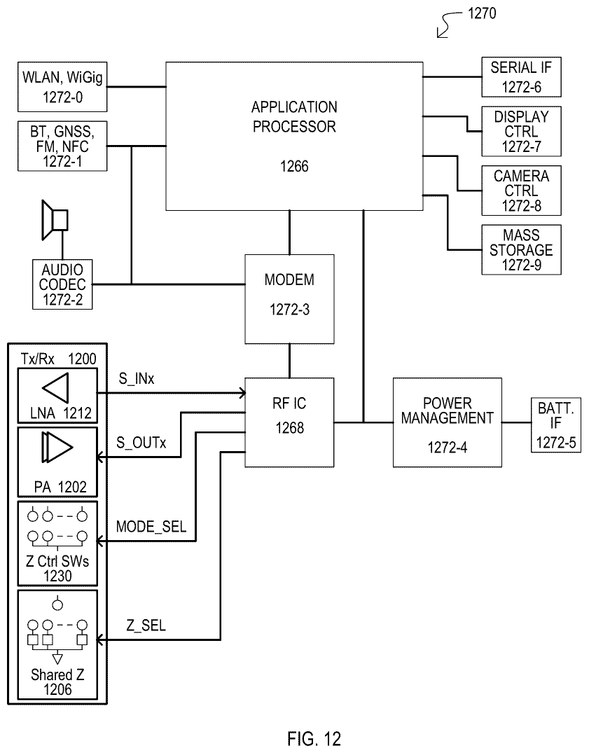

FIG. 12 is a diagram of a mobile device 1270 according to an embodiment. A mobile device 1270 can include an application processor 1266, an RF IC 1268, Tx/Rx system 1200, Wi-Fi circuits 1272-0, other wireless circuits 1272-1, audio encoder/decoder 1272-2, modem circuits 1272-3, power management circuits 1272-4, battery interface (IF) 1272-5, serial IF 1272-6, display control 1272-7, camera control 1272-8, and mass storage 1272-9. An application processor 1266 can execute various operations of the mobile device, and can include processor circuits and any other suitable other circuits, including but not limited to memory circuits, IO circuits, and bus control circuits.

An RF IC 1268 can control operations of Tx/Rx system 1200, which can be an RF front end, in some embodiments. An RF IC 1288 can take any suitable form, and in particular embodiments can control cellular RF operations for a mobile device 1270. RF IC 1288 and provide output signals to, and receive input signals from, Tx/Rx system 1200. A Tx/Rx system 1200 can include one or more LNA circuits 1212, one or more PA circuits 1202, impedance control switch circuit 1230 and shared matching network 1206. LNA and PA circuits 1212/1202 can take the form of any of those described herein or equivalents. In some embodiments, all or part of Tx/Rx system 1200 can be part of RF IC 1268.

Impedance control switch circuit 1230 can control switching circuits to exclude or otherwise reduce the adverse effects of a transmit circuit components on an input impedance, as described herein and equivalents. In addition, in some embodiments, impedance control switch circuit 1230 can remove or otherwise reduce the effect of receive circuit components on a transmit load/impedance, as described herein and equivalents. A shared matching network 1206 can take the form of any of those described herein, or equivalents, and can be present in both a signal output path and a signal input path. In the embodiment shown, shared matching network 1206 can provide a selectable matching impedance in response to signals Z_SEL. However, alternate embodiments can include a shared network 1206 with a fixed impedance.

A Wi-Fi circuit 1272-0 can include circuits suitable for providing communications functions according to one or more IEEE 802.11 wireless standards. Other wireless circuits 1272-1 can include circuits for providing wireless communications according to one or more other standards, including but not limited to, a Bluetooth (BT) standard, communications for navigation systems (e.g., GNSS), other frequency modulation (FM) systems, and one or more near field communication (NFC) systems.

An audio codec 1272-2 can provide encoding of audio signals (e.g., from a microphone) and decoding of audio signals for output (e.g., to a speaker). A modem circuit 1272-3 can provide modulation for outgoing signals and demodulation for incoming signals. In some embodiments, RF modulation/demodulation can be included in RF IC 1268. In the embodiment shown, modem circuits 1272-3 can provide modulated signals to and demodulate signals received from other wireless circuits 1272-1 and audio codec 1272-2.

Power management circuits 1272-4 can control power distribution to various portions of a wireless device 1270. In the embodiment shown, power management circuits 1272-4 can be connected to a battery IF 1272-5.

A serial IF 1276-6 can enable one or more other devices to communicate with a mobile device 1270, and can include interfaces compatible with any of: a serial digital interface (SDI) standard, a universal serial bus (USB) standard, a universal asynchronous receiver transmitter (UART) standard, an I2C standard, or an I2S standard, as but a few examples. A display control 1272-7 can control a display for a mobile device (not shown), including a display that can function as a user interface (e.g., touchscreen). A camera control 1272-8 can control a camera (not shown) for the mobile device. Mass storage 1272-9 can include any suitable circuits for storing data for mobile device 1270, including nonvolatile memory, volatile memory and combinations thereof.

In this way, a mobile device can include RF circuits with a shared network, all or a portion of which, is included in both a signal transmission and signal reception path. Switching circuits can be included that can remove or eliminate adverse effects of transmission components on an input impedance for an input signal.

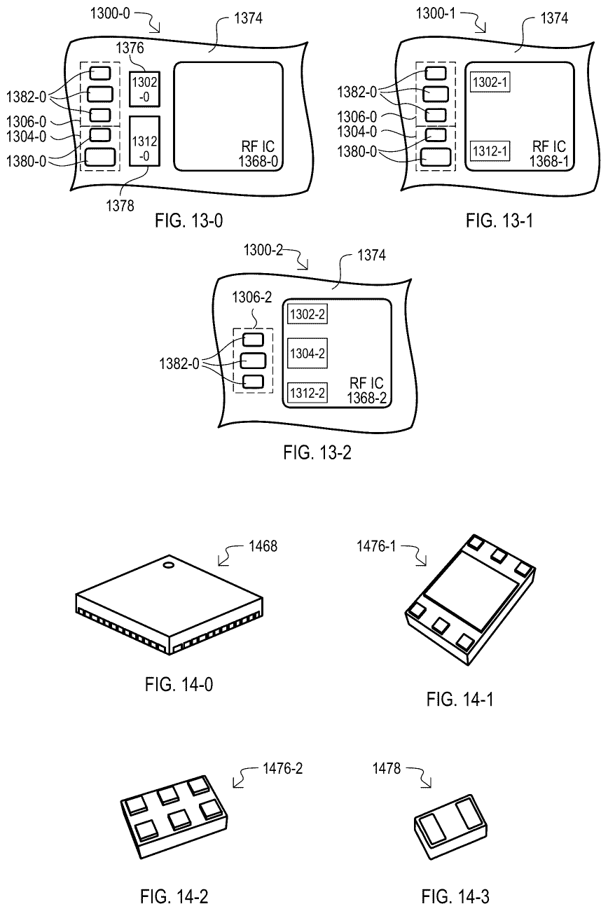

FIGS. 13-0 to 13-2 are top views of systems according to various embodiments. FIG. 13-0 shows components formed on a substrate 1374, which can include, but is not limited to, a circuit board or the like. Substrate 1374 can provide conductive paths between mounted components in any suitable fashion, including surface trace lines, or one or more interconnect layers within the substrate 1372. Components can include a RF IC 1368-0, transmit amplifier circuits 1302-0, transmit components 1304-0, shared network 1306-0, and receive amplifier circuits 1312-0. Transmit amplifier circuits 1302-0 can be included in an IC package 1376 mounted on a substrate 1374 separate from RF IC 1368-0. Receive amplifier circuits 1312-0 can be included in an IC package 1378 mounted on substrate 1374 separate from RF IC 1368-0.

Transmit components 1304-0 can include in one or more packages 1380-0 mounted to substrate 1374. Such packages 1380-0 can include all or a portion of transmit components as described herein or equivalents, including but not limited to a transformer, switching device, or passive components (e.g., capacitor, inductor). It is understood that transmit components 1304-0 can be switched between at least a transmit and receive configuration, where, in the receive configuration an adverse presented by transmitted components can be removed or reduced. Switching of transmit components can be performed, all or in part, by active devices included in transmit components and/or active devices included in RF IC 1368-2.

Shared network 1306-0 can include in one or more packages 1382-0 mounted to substrate 1374. Such packages 1382-0 can include all or a portion of a shared network as described herein or equivalents, including but not limited to inductors, capacitors. In some embodiments a shared network can provide a selectable impedance. In such cases network switching devices can select an impedance, where such switching devices can be included in shared network 1306-0 and/or RF IC 1368-2. It is understood that all or a portion of shared network 1306-0 can be included in a transmit signal path and receive signal path.

FIG. 13-1 is a diagram of a system 1300-1 according to another embodiment. A system 1300-1 can include items like those of FIG. 13-0, and such like items are referred to by the same reference characters. FIG. 13-1 can differ from that of FIG. 13-0 in that all or a portion of transmit amplifier circuits 1302-1 and receive amplifier circuits 1312-1 can be included in RF IC 1368-1.

FIG. 13-2 is a diagram of a system 1300-2 according to a further embodiment. A system 1300-2 can include items like those of FIG. 13-1, and such like items are referred to by the same reference characters. FIG. 13-2 can differ from that of FIG. 13-1 in that all or a portion of transmit components 1302-4 can be included in RF IC 1368-2.

In some embodiments, packages 1380-0/1/2 and/or 1382-0/1 can be surface mount packages.

In this way, a system can include impedance matching for a shared network mounted on a substrate, with an RF IC, where the system can include switching devices for essentially excluding a transmit components effect on an input impedance.

While FIGS. 13-0 to 13-1 show matching network components separate from a corresponding RF IC, alternate embodiments can include all or a portion of matching network components integrated into a same RF IC.

FIGS. 14-0 to 14-3 show packages that can be included in embodiments. FIG. 14-0 shows one example of a RF IC package 1468 that can be included in embodiments. FIG. 14-1 shows one example of transmit component package 1476-1 that can be included in embodiments. Such a package 1476-1 can include, but is not limited to, any of: an RF transformer and switching devices. Such switching devices can configure an RF transformer from adversely affecting an input impedance as described herein and equivalents. FIG. 14-2 shows one example of a switch component package 1476-2 that can be included in embodiments. Such a package 1476-2 can include switching devices that can configure an RF transformer, or other transmit components, from adversely affecting an input impedance as described herein and equivalents. FIG. 14-3 shows one example of a passive component package 14-3 that can be included in embodiments. Such a package 1476-3 can include one or more passive components that can be included in shared matching impedance network as described herein, or equivalents.

In this way, various portions of embodiments can be included in one or more packages for mounting on a substrate, such as a circuit board.

While embodiments can enjoy application in any suitable system that includes wireless communications, particular systems will now be described.

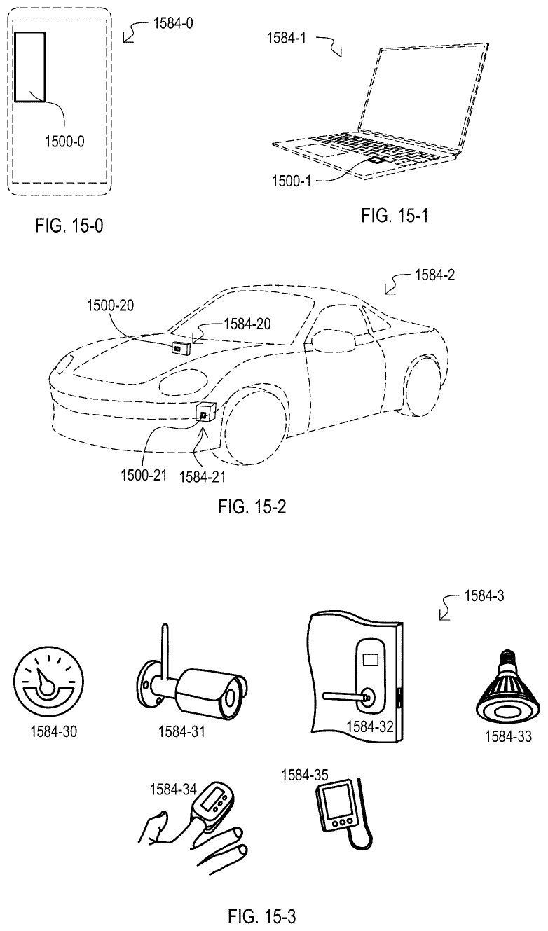

FIG. 15-0 is a diagram of a mobile (e.g., smart phone) device system 1584-0 according to an embodiment. System 1584 can include a Tx/Rx system 1500-0 according to embodiments described herein or equivalents. In some embodiments, Tx/Rx system 1500-0 can include a circuit board with one or more RF ICs and shared network components mounted thereon, as described herein and equivalents.

FIG. 15-1 is a diagram of a portable computing device system (e.g., laptop computer) 1584-0 according to an embodiment. System 1584-1 can include a Tx/Rx system 1500-1 according to any of the embodiments described herein or equivalents.

FIG. 15-2 is a diagram of a motor vehicle device system 1584-2 according to an embodiment. A motor vehicle system 1584-2 can have numerous sub-systems (two shown as 1584-20 and 1584-21) that include wireless communications. Such sub-systems (1584-20/21) can include, but are not limited to, an electronic control unit (ECU) and/or an in-vehicle infotainment (IVI) system. A sub-system (1584-20/21) can include a Tx/Rx system 1500-20/21 according to any of the embodiments described herein or equivalents.

FIG. 15-3 shows various other systems according to embodiments. Such systems can include Internet-of-things (IoT) type devices, including but not limited to, instrumentation devices 1584-30, security devices 1584-31/32, lighting devices 1584-33, and/or medical devices 1584-34/35. Such devices can include Tx/Rx systems as described herein and equivalents. Each of systems (1584-0 to 35) can include a transmit mode that transmits an output signal through shared impedance matching network, and a receive mode in which switching devices can exclude or otherwise reduce the adverse effects of transmit components when an input signal is received through matching network.

In this way, various types of devices can benefit from the advantageous features of Tx/Rx paths as described herein and equivalents.

While the systems and devices described herein show various methods and operations, additional methods will now be described with reference to flow diagrams. Such methods can be executed by devices and systems described herein.

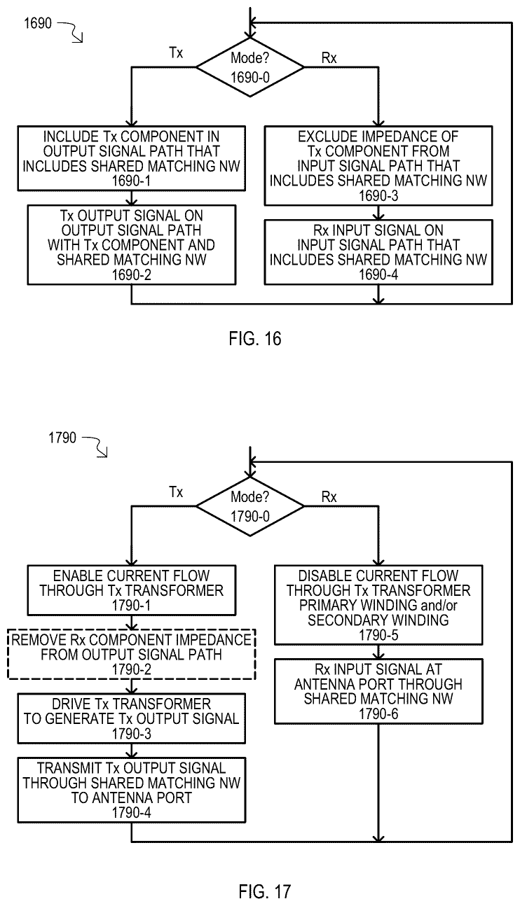

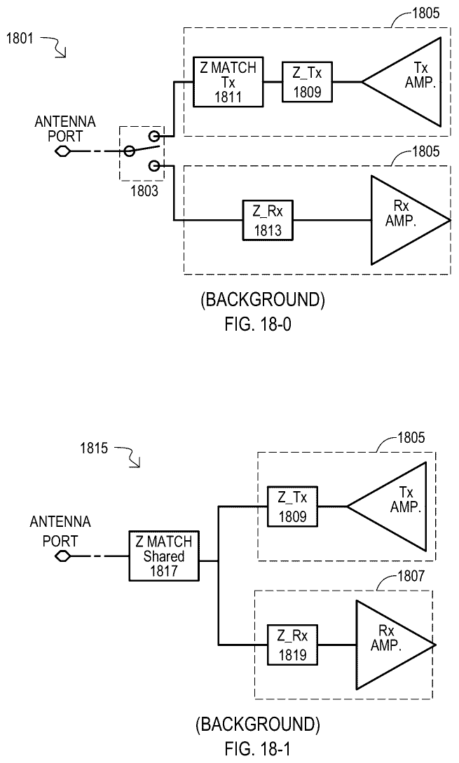

FIG. 16 is a flow diagram of a method 1690 according to an embodiment. A method 1690 can include determining between modes of operation, including but not limited to, a transmit (Tx) mode or receive (Rx) mode 1690-0. Such an action can include any suitable system control, including an application running on a device, indicating of mode of operation. Further, in some embodiments a method 1690 can include a default mode (e.g., Rx), and periodically switch to another mode (e.g., Tx).

In a Tx mode (Tx from 1690-0), a transmit component can be included in an output signal that includes a shared network 1690-1. Such an action can include any of those described herein, including but not limited to switching devices enabling a current path for a transmit component, such as a RF transformer, and/or connecting such a transmit component to an output signal path. An output signal can be transmitted with a transmit component through a shared matching network 1690-2. Such an action can include, but is not limited to, amplifying an output signal and driving it through a shared matching network, where the shared matching network improves transmission efficiency by better matching the impedance of the output signal path to that of transmission circuits, including the transmit component.

In a Rx mode (Rx from 1690-0), an impedance of a Tx component can be excluded from an input signal path that includes a shared matching network 1690-3. Such an action can include any of those described herein, including but not limited to switching devices disabling a current path for a transmit component, such as a RF transformer, and/or disconnecting such a transmit component from an input signal path. As noted herein, excluding an impedance can include altering a transmit component so that its impedance is very high relative to other components in the input path, and thus does not affect an input impedance. An input signal can be received on an input signal path that includes a shared matching network 1690-4. Such an action can include any of those described herein, and equivalent, including but not limited to receiving a wireless signal through all or a portion of the same impedance matching network used to optimize and output signal (e.g., use impedance matching to reduce power loss).

In this way, a method can include a transmit mode, in which an output signal is transmitted through/with a transmit component and through a matching network. The method can also include a receive mode, in which an input signal can be received through the same matching network, while an impedance presented by the transmit component is essentially excluded from an overall input impedance for the input signal.

FIG. 17 is a flow diagram of a method 1790 according to another embodiment. A method 1790 can include determining between modes of operation 1790-0. Such an action can include any of those described for 1690-0 of FIG. 16 and equivalents.

In a Tx mode (Tx from 1690-0), a method include enabling a current flow through a transmit transformer 1790-1. Such an action can include any of those described herein and equivalents, including but not limited to, enabling current in both primary and secondary windings of a transmit transformer and/or enabling a current path between a transmit transformer and a shared network.

Optionally, a method can include removing a receive impedance from an output signal path 1690-2. As understood from herein, removing such an impedance can include creating a relatively low impedance across the input device (e.g., shorting across the input impedance).

Also in a Tx mode, a transmit transformer can be driven to generate an output signal (1790-3). Such an action can include any suitable approach for generating current through a primary winding, including but not limited to tapped and non-tapped transformer structures. Further, a transmit transformer can be driven directly by a transmit amplifier or through one or more other devices. An output signal can be transmitted through a shared matching network to an antenna port 1790-4. Such an action can include any of those described herein, including a shared matching network configured to improve power transfer.

In a Rx mode (Rx from 1790-0), a method can include disabling a current flow through a transmit transformer primary winding and/or secondary winding 1790-5. Such an action can include any of those described herein, or equivalents, including but not limited to, equalizing and shorting terminals of a tapped primary winding, isolating a primary winding from a current source (e.g., low or high power supply voltage), isolating a secondary winding from a current source (e.g., low or high power supply voltage). An input signal can be received at an antenna port and through a shared matching network 1790-7. Such an action can include any of those described herein and equivalents.

In this way, a method can include a transmit mode, in which current flow through a transmit amplifier can generate an output signal that is transmitted through a matching network. In a receive mode, current can be prevented from flowing through a transmit amplifier to prevent the transmit amplifier from adversely affecting an input impedance. An input signal can be received through the same matching network.

Embodiments can advantageously provide an alternative to systems that include switching between transmit and receive paths, by enabling a matching network to be shared by both transmit and receive paths.

Embodiments can advantageously reduce device cost as switching devices for creating separate transmit and receive paths can be omitted from a system.

Embodiments can advantageously reduce device size by enabling larger Tx/Rx switching devices to be omitted from a system.

Embodiments can include methods, devices and systems that include, by operation of wireless circuits of a wireless device, providing a transmit mode and a receive mode. In a transmit mode, by operation of transmit switch circuits, including a transmit component in an output signal path between a transmit amplifier and an antenna port, the output signal path including a shared matching network. By operation of the transmit amplifier, generating an output signal for transmission over the output signal path to the antenna port. In a receive mode, by operation of the transmit switch circuits, excluding an input impedance of the transmit component from an input signal path between the antenna path and a receive amplifier, the input signal path including the shared matching network. By operation of the receive amplifier, amplifying the received input signal.

Embodiments can include methods, devices and systems that include an antenna port and wireless circuits. Wireless circuits can include a transmit amplifier configured to amplify an output signal, a receive amplifier configured to amplify an input signal, a shared matching network having a first terminal coupled to an output of the transmit amplifier and an input of the receive amplifier, a transmit component coupled between the output of the transmit amplifier and the antenna port, and transmit switch circuits coupled to the output component. The transmit components can be configured to, in a transmit mode, include the transmit component in an output signal path from the transmit amplifier through the shared matching network and to the antenna port, and in a receive mode, exclude and input impedance of the transmit component from an input signal path from the antenna port through the shared matching network and to the receive amplifier.

Embodiments can include methods, devices and systems that include, an antenna system coupled to an antenna port and a wireless device. A wireless device can include a transmit amplifier configured to amplify an output signal, a receive amplifier configured to amplify an input signal, a shared matching network having a first terminal coupled to an output of the transmit amplifier and an input of the receive amplifier, a transmit component coupled to an output of the transmit amplifier, and transmit switch circuits coupled to the transmit component. Transmit switch circuits can be configured to, in a transmit mode, include the transmit component in an output signal path from the transmit amplifier through the shared matching network and to the antenna port, and in a receive mode, exclude an input impedance of the transmit component from an input signal path from the antenna port through the shared matching network and to the receive amplifier.

Methods, devices and systems according to embodiments can include, in a receive mode, by operation of receive switch circuits, including a receive component in the input signal path. In a transmit mode, by operation of the receive switch circuits, an output impedance of the receive component from the output signal path.

Methods, devices and systems according to embodiments can include, a transmit component having a primary transformer winding coupled to an output of the transmit amplifier, and at least one secondary winding coupled to at least the shared matching network. Including a transmit component in the output signal path can include enabling current flow through the primary transformer winding. Excluding an input impedance of the transmit component from the input signal path can include disabling current flow through the primary transformer winding.

Methods, devices and systems according to embodiments can include providing a high impedance path between first and second terminals of a primary transfer winding by enabling current flow through the primary transformer winding by operation of transmit switch circuits. Providing a low impedance path between first and second terminals of a primary transfer winding can include enabling current flow through the primary transformer winding by operation of transmit switch circuits.

Methods, devices and systems according to embodiments can include a primary transformer winding being a center-tapped winding having a center-tap node located between first and second terminals of the primary transformer winding. Enabling current flow through a primary transformer winding can include, by operation of the transmit switch circuits, providing a low impedance path between the center-tap node and a power supply node. Disabling a current flow through the primary transformer winding can include, by operation of the transmit switch circuits, creating a high impedance path between the center-tap node and the power supply node.

Methods, devices and systems according to embodiments can include a transmit component having a primary transformer winding coupled to an output of the transmit amplifier and at least one secondary winding having a first terminal coupled to at least the shared impedance. Including a transmit component in an output signal path can include enabling current flow through the secondary transformer winding. Excluding an input impedance of the transmit component from the input signal path can include disabling current flow through the secondary transformer winding.

Methods, devices and systems according to embodiments can include enabling a low impedance path between a secondary transformer winding by transmit switch circuits enabling a low impedance path between a second terminal of the secondary transformer windings and a reference potential node. Disabling a current flow through secondary transformer winding can include transmit switch circuits creating a high impedance path between a second terminal of the secondary transformer windings and the reference potential node.

Methods, devices and systems according to embodiments can include enabling current flow through the secondary transformer winding by transmit switch circuits enabling a low impedance path between a first terminal of the secondary transformer windings and a shared matching network. Disabling current flow through a secondary transformer winding can include transmit switch circuits creating a high impedance path between a first terminal of the secondary transformer windings and the shared matching network.

Methods, devices and systems according to embodiments can include receive switch circuits configured to, in the receive mode, include a receive component in the input signal path, and in the transmit mode, remove an output impedance of the receive component from the output signal path.

Methods, devices and systems according to embodiments can include receive switch circuits that include at least one insulated gate field effect transistor coupled between the receive component and a reference voltage node.

Methods, devices and systems according to embodiments can include a receive component including a capacitive element and an inductive element in series between the shared matching network and a receive amplifier.

Methods, devices and systems according to embodiments can include a transmit component including a transformer with a primary winding coupled to the output of the transmit amplifier and a secondary winding coupled to the shared matching network. Transmit switch circuits can include at least one insulated gate field effect transistor having a source-drain path coupled to at least one terminal of the primary winding.

Methods, devices and systems according to embodiments can include a transmit component including a transformer having a primary winding coupled to an output of the transmit amplifier and a secondary winding having a first terminal coupled to the shared matching network and a second terminal. Transmit switch circuits can include any of: at least one insulated gate field effect transistor having a source-drain path coupled between the second terminal of the secondary winding and a reference voltage terminal, and at least one insulated gate field effect transistor having a source-drain path coupled between the first terminal of the secondary winding and the shared matching network.

Methods, devices and systems according to embodiments can include a shared matching network having at least a first passive circuit element in series between the antenna port and the transmit amplifier and receive amplifier, and at least a second passive circuit element between the first passive circuit element and a reference voltage node. First and second passive circuit elements can be a capacitor or inductor.

Methods, devices and systems according to embodiments can include a transmit amplifier and receive amplifier formed in at least one integrated circuit package mounted to a circuit substrate. First and second passive circuit elements can comprise surface mounted packages mounted to the circuit substrate.

Methods, devices and systems according to embodiments can include a transmit component including a transformer having a primary winding with a first terminal coupled to an output of the transmit amplifier and a second terminal, and a secondary winding coupled to the shared matching network. Transmit switch circuits can include at least one insulated gate field effect transistor having a source-drain path coupled to at least one terminal of the primary winding.

Methods, devices and systems according to embodiments can include a transmit component including a transformer having a primary winding with a first terminal coupled to an output of the transmit amplifier and a second terminal and a secondary winding coupled to the shared matching network. Transmit switch circuits can include at least one insulated gate field effect transistor having a source-drain path coupled to at least one terminal of the secondary winding.

Methods, devices and systems according to embodiments can include a transmit and receive amplifier formed in at least one integrated circuit package attached to a circuit board. An antenna port can be formed on the circuit board. A transmit component can include a transformer attached to the circuit board. A shared matching network can include at least a first passive circuit element attached to the circuit board and coupled between the antenna port and both the transmit amplifier and receive amplifier, and at least a second passive element attached to the circuit board and coupled to the first passive circuit element.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of wireless circuits of a wireless device,
in a transmit mode
by operation of transmit switch circuits, including a transmit component in an output signal path between a transmit amplifier and an antenna port, the output signal path including a shared matching network, and
by operation of the transmit amplifier, generating an output signal for transmission over the output signal path to the antenna port; and
in a receive mode
by operation of the transmit switch circuits, excluding an input impedance of the transmit component from an input signal path between the antenna path and a receive amplifier, the input signal path including the shared matching network, and
by operation of the receive amplifier, amplifying the received input signal.

2. The method of claim 1, further including:
in the receive mode, by operation of receive switch circuits, including a receive component in the input signal path; and
in the transmit mode, by operation of the receive switch circuits, removing an output impedance of the receive component from the output signal path.

3. The method of claim 1, wherein:
the transmit component includes
a primary transformer winding coupled to an output of the transmit amplifier, and
at least one secondary winding coupled to at least the shared matching network; and
including the transmit component in the output signal path comprises enabling current flow through the primary transformer winding; and
excluding the input impedance of the transmit component from the input signal path comprises disabling current flow through the primary transformer winding.

4. The method of claim 3, wherein:
enabling current flow through the primary transformer winding includes, by operation of the transmit switch circuits, providing a high impedance path between first and second terminals of the primary transformer winding; and
disabling current flow through the primary transformer winding includes, by operation of the transmit switch circuits, providing a low impedance path between first and second terminals of the primary transformer winding.

5. The method of claim 3, wherein:
the primary transformer winding comprises a center-tapped winding having a center-tap node located between first and second terminals of the primary transformer winding;
enabling current flow through the primary transformer winding includes, by operation of the transmit switch circuits, providing a low impedance path between the center-tap node and a power supply node; and
disabling current flow through the primary transformer winding includes, by operation of the transmit switch circuits, creating a high impedance path between the center-tap node and the power supply node.

6. The method of claim 1, wherein:
the transmit component includes
a primary transformer winding coupled to an output of the transmit amplifier, and
at least one secondary winding having a first terminal coupled to at least the shared impedance; and
including the transmit component in the output signal path comprises enabling current flow through the secondary transformer winding; and
excluding the input impedance of the transmit component from the input signal path comprises disabling current flow through the secondary transformer winding.

7. The method of claim 6, wherein:
enabling current flow through the secondary transformer winding comprises, by operation of the transmit switch circuits, enabling a low impedance path between a second terminal of the secondary transformer windings and a reference potential node, and
disabling current flow through the secondary transformer winding comprises, by operation of the transmit switch circuits, creating a high impedance path between the second terminal of the secondary transformer windings and the reference potential node.

8. The method of claim 6, wherein:
enabling current flow through the secondary transformer winding comprises, by operation of the transmit switch circuits, enabling a low impedance path between the first terminal of the secondary transformer windings and the shared matching network, and
disabling current flow through the secondary transformer winding comprises, by operation of the transmit switch circuits, creating a high impedance path between the first terminal of the secondary transformer windings and the shared matching network.

9. A device, comprising:
an antenna port;
wireless circuits that include
a transmit amplifier configured to amplify an output signal,
a receive amplifier configured to amplify an input signal,
a shared matching network having a first terminal coupled to an output of the transmit amplifier and an input of the receive amplifier,
a transmit component coupled between the output of the transmit amplifier and the antenna port, and
transmit switch circuits coupled to the output component and configured to,
in a transmit mode, include the transmit component in an output signal path from the transmit amplifier through the shared matching network and to the antenna port, and
in a receive mode, exclude and input impedance of the transmit component from an input signal path from the antenna port through the shared matching network and to the receive amplifier.

10. The device of claim 9, further including:
receive switch circuits configured to,
in the receive mode, include a receive component in the input signal path, and
in the transmit mode, remove an output impedance of the receive component from the output signal path.

11. The device of claim 10, wherein the receive switch circuits include at least one insulated gate field effect transistor coupled between the receive component and a reference voltage node.

12. The device of claim 10, wherein the receive component comprises a capacitive element and inductive element in series between the shared matching network and the receive amplifier.

13. The device of claim 9, wherein:
the transmit component comprises a transformer having
a primary winding coupled to the output of the transmit amplifier, and
a secondary winding coupled to the shared matching network; and
the transmit switch circuits comprise at least one insulated gate field effect transistor having a source-drain path coupled to at least one terminal of the primary winding.

14. The device of claim 9, wherein:
a transmit component comprises a transformer having
a primary winding coupled to an output of the transmit amplifier, and
a secondary winding having a first terminal coupled to the shared matching network and a second terminal; and
the transmit switch circuits comprise a configuration selected from the group of:
at least one insulated gate field effect transistor having a source-drain path coupled between the second terminal of the secondary winding and a reference voltage terminal, and
at least one insulated gate field effect transistor having a source-drain path coupled between the first terminal of the secondary winding and the shared matching network.

15. The device of claim 9, wherein:
the shared matching network includes
at least a first passive circuit element in series between the antenna port and the transmit amplifier and receive amplifier, and
at least a second passive circuit element between the first passive circuit element and a reference voltage node; wherein
the first and second passive circuit elements are selected from the group of a capacitor and inductor.

16. The device of claim 9, wherein:
the transmit amplifier and receive amplifier are formed in at least one integrated circuit package mounted to a circuit substrate; and
the first and second passive circuit elements comprise surface mounted packages mounted to the circuit substrate.

17. A system, comprising:
an antenna system coupled to an antenna port; and
a wireless device that includes
a transmit amplifier configured to amplify an output signal,
a receive amplifier configured to amplify an input signal,
a shared matching network having a first terminal coupled to an output of the transmit amplifier and an input of the receive amplifier,
a transmit component coupled to an output of the transmit amplifier, and
transmit switch circuits coupled to the transmit component and configured to,
in a transmit mode, include the transmit component in an output signal path from the transmit amplifier through the shared matching network and to the antenna port, and
in a receive mode, exclude an input impedance of the transmit component from an input signal path from the antenna port through the shared matching network and to the receive amplifier.

18. The system of claim 17, wherein:
the transmit component comprises a transformer having
a primary winding with a first terminal coupled to an output of the transmit amplifier and a second terminal, and
a secondary winding coupled to the shared matching network; and
the transmit switch circuits comprise at least one insulated gate field effect transistor having a source-drain path coupled to at least one terminal of the primary winding.

19. The system of claim 17, wherein:
the transmit component comprises a transformer having
a primary winding with a first terminal coupled to an output of the transmit amplifier and a second terminal, and
a secondary winding coupled to the shared matching network; and
the transmit switch circuits comprise at least one insulated gate field effect transistor having a source-drain path coupled to at least one terminal of the secondary winding.

20. The system of claim 17, wherein:
the transmit and receive amplifier are formed in at least one integrated circuit package attached to a circuit board;
the antenna port is formed on the circuit board;
the transmit component comprises a transformer attached to the circuit board; and
the shared matching network comprises
at least a first passive circuit element attached to the circuit board and coupled between the antenna port and both the transmit amplifier and receive amplifier, and
at least a second passive element attached to the circuit board and coupled to the first passive circuit element.
